(19) United States
(12) Patent Application Publication
(10) Pub. No.: US 2004/0260598 A1
(43) Pub. Date: Dec. 23, 2004

(54) Method and apparatus for notifying vendors of flight plan changes in order to target advertising

(75) Inventors: David Bruce Kumhyr, Austin, TX (US); Janani Janakiraman, Austin, TX (US); Dustin C. Kirkland, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/465,066

(22) Filed: Jun. 19, 2003

(51) Int. Cl. G06F 17/60

(52) U.S. Cl. 705/10

(57) ABSTRACT

An apparatus and method for gathering flight plan data and passenger manifest data for analysis to determine whether to send a notification of a condition representing a possible business opportunity to one or more vendors providing goods and/or services to airline passengers are provided. In one embodiment, the raw data is used to compare against notification criteria established by vendors to determine if a notification is to be sent to the vendors. In another embodiment, data mining and knowledge paradigms are used to extract relationship information from the data to obtain a prediction as to the needs of the passengers on airline flights and to notify appropriate vendors prior to the passengers arriving at the airport. The apparatus and method generates an appropriate notification detailing the conditions giving rise to the notification. This notification is then transmitted to the registered vendors based on the vendors' established profiles, for embodiments in which raw data comparison is performed. For embodiments in which data mining techniques are used, the apparatus and method identifies the types of goods and services that passengers will probably be in need of and identifies registered vendors that provide those goods and/or services. Notifications are then sent to the identified vendors.

### RELATED APPLICATION

The present invention is directed to similar subject matter as found in commonly assigned and co-pending U.S. patent application Ser. No. 10/171,944, entitled “System and Method for Network Tracking of Passenger Travel Progress,” filed on Jun. 13, 2002, which is hereby incorporated by reference.

### BACKGROUND OF THE INVENTION

1. Technical Field

The present invention is directed to a method and apparatus for notifying vendors of flight plan changes. More specifically, the present invention is directed to mechanisms for informing vendors of possible customers based on changes to flight plans so that the vendors may advertise their goods/services to passengers of flights meeting certain criteria.

2. Description of Related Art

Modern air travel is increasingly complex due to the vast network of commercial airplanes traveling to thousands of cities to drop passengers off and pick them up. Coupled with this complexity are increased security measures that make it more difficult for passengers to get to boarding areas and more difficult for people waiting for passengers to pick them up. In many airports today, people who do not have tickets are not allowed to pass through security to wait for passengers. Most airports were designed before these tighter security measures were enacted and, therefore, have limited waiting areas outside the secure area.

In addition to the difficulties experienced by passengers and people waiting for or with those passengers, modern air travel has placed difficulties on airport associated vendors in providing goods and services to these passengers and people associated with the passengers. Because of cancellations of flights, large delays, requirements to arrive at airports two or more hours before the flight departure time, and other factors, vendors have found it necessary to have additional capacity to service passengers and associated persons. However, the vendors typically do not know in advance when such additional capacity will be necessary beyond those historically well established heavy travel times such as Thanksgiving, Christmas, and the like.

In view of the above, it would be beneficial to have an apparatus and method for dynamically notifying vendors of goods and services of changes in flight plans so that the vendors may target advertising of their goods and services to passengers of aircraft based on the most probable needs of the passengers in view of their circumstances.

### SUMMARY OF THE INVENTION

The present invention provides an apparatus and method for gathering flight plan data and passenger manifest data for analysis to determine whether to send a notification of a condition representing a possible business opportunity to one or more vendors providing goods and/or services to airline passengers. In one embodiment, the raw data is used to compare against notification criteria established by vendors to determine if a notification is to be sent to the vendors. In another embodiment, data mining and knowledge paradigms are used to extract relationship information from the data to obtain a prediction as to the needs of the passengers on airline flights and to notify appropriate vendors prior to the passengers arriving at the airport.

If it is determined that a notification is to be sent, the apparatus and method generates an appropriate notification method detailing the conditions giving rise to the notification. This notification is then transmitted to the registered vendors based on the vendors' established profiles, for embodiments in which raw data comparison is performed. For embodiments in which data mining techniques are used, the apparatus and method identifies the types of goods and services that passengers will probably be in need of and identifies registered vendors that provide those goods and/or services. Notifications are then sent to the identified registered vendors.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which the present invention may be implemented;

FIG. 2 is an exemplary diagram of a server computing device in accordance with an exemplary embodiment of the present invention;

FIG. 3 is an exemplary diagram of a client computing device in accordance with an exemplary embodiment of the present invention;

FIG. 4 is an exemplary diagram illustrating an interaction of the vendor notification system with databases of flight, passenger and vendor information in accordance with an exemplary embodiment of the present invention;

FIG. 5 is an exemplary diagram illustrating a vendor profile form according to one exemplary embodiment of the present invention;

FIG. 6 is an exemplary diagram of a notification sent to a vendor computing device in accordance with the present invention; and

FIG. 7 is a flowchart outlining an exemplary operation of the present invention.

### DETAILED DESCRIPTION OF THE PREFERRED EMBODIMENTS

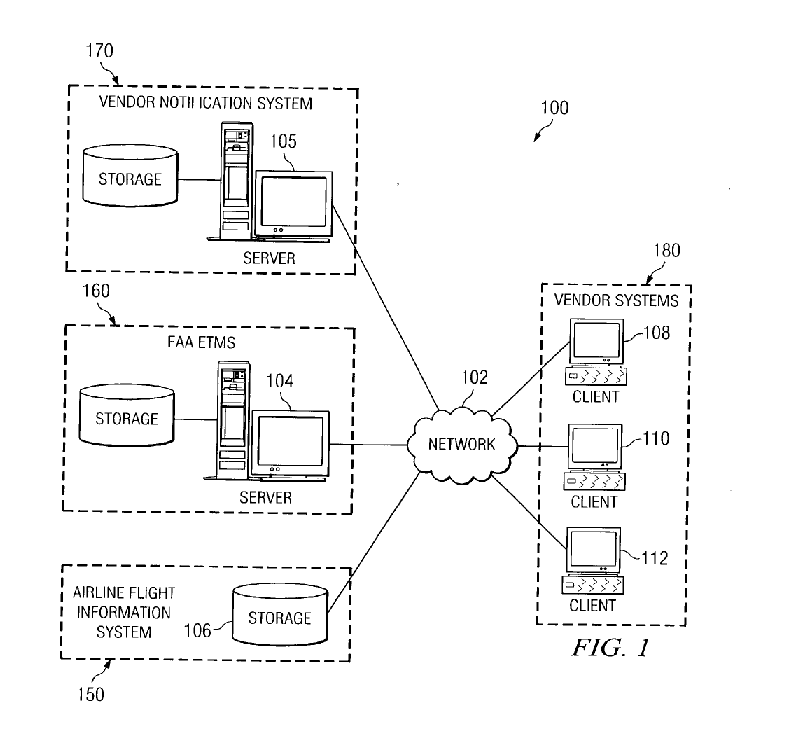

The present invention provides a mechanism for identifying conditions of flights that meet notification criteria for one or more vendors and sending notifications to these vendors so that they may target their advertising to passengers of the flights based on the most probable need of those passengers. The present invention is preferably implemented in a distributed data processing system and thus, the following FIGS. 1-3 are provided in order to give a context in which the present invention will later be described.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104 and 105 are connected to network 102 along with storage unit 106. In addition, clients 108, 110, and 112 are connected to network 102. These clients 108, 110, and 112 may be, for example, personal computers or network computers. In the depicted example, servers 104 and 105 may provide data, such as boot files, operating system images, and applications to clients 108-112. Clients 108, 110, and 112 are clients to servers 104 and 105. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In accordance with the present invention, the server 104 may be associated with a Federal Aviation Administration (FAA) Enhanced Traffic Management System (ETMS) 160 which stores information regarding flights for all aircraft flying using “instrument flight rules” (IFR, i.e. the rules under which commercial airlines and most charter and corporate airlines operate). The FAA ETMS database contains all flight plan information for flights in the National Airspace System (NAS). Data is collected from the entire population of flights in the NAS with filed flight plans. ETMS data is sent from the Volpe National Transportation System Center (VNTSC) to registered participants via the Aircraft Situation Display to Industry (ASDI) electronic file server.

With the FAA ETMS, data is contained in ten message types, outlined below:

1. AF messages: Provide information concerning a revised flight plan whenever an existing flight plan is amended.

2. AZ messages: Provide information concerning the arrival of a flight pending arrival.

3. DZ messages: Provide information concerning the departure of departing flights.

4. FZ messages: Provide flight plan information.

5. RZ messages: Provide information concerning a flight's cancellation.

6. TZ messages: Provide information concerning a flight's position.

7. UZ messages: Provide information concerning a flight's crossing of an Air Route Traffic Control Center (ARTCC) boundary.

8. RT messages: Provide information on updated predictions, such as a flight's estimated time of arrival.

9. TO messages: Provide information on an oceanic flight's position.

10. HB messages: Indicate that the connection between the ASDI server and the client is intact.

These messages are used to compile a database of data for each flight within the National Airspace System. The compiled data in this FAA ETMS database may be stored and accessible by the present invention via the server 104. The server 104 provides a mechanism by which the data stored in the FAA ETMS database may be queried and retrieved for use by the present invention to determine whether to notify vendors of a condition of interest to the vendors.

In addition to the FAA ETMS 160, the present invention obtains information from an airline flight information system 150 of which storage device 106 may be a part. The storage device 106 may store information, for example, regarding the type of aircraft being used for each flight of an airline, the maximum number of passengers, the actual number of passengers, and passenger manifest information for specific flights. The passenger manifest information may include names of passengers, destinations of passengers, connecting flight information for particular passengers, and the like.

The information from the airline flight information system 150 and the FAA ETMS 160 may be provided to the vendor notification system 170 for use in determining whether to notify vendors of potentially profitable situations. That is, the data obtained from the airline flight information system 150 along with the data obtained from the FAA ETMS 160 may be used to compare to established notification thresholds set by vendors indicating when the vendor wishes to be notified of a condition indicative of a potential business opportunity. In such an embodiment, raw data from the airline flight information system 150 and the FAA ETMS 160 may be used to make determinations as to whether the flight is late and by how much time the flight is late, a flight has been overbooked, a flight has been canceled, what gate locations passengers will need to pass by in order to exit the airport or meet connecting flights, and the like. These determinations can then be used to compare to the thresholds established in vendor profiles of registered vendors to determine which vendors should receive notifications. The notifications are then generated and transmitted to the vendors so that they may take appropriate actions to make use of the potential business opportunity.

In another embodiment of the present invention, the data gathered from the FAA ETMS 160 and the airline flight information server 150 are mined by data mining algorithms to determine complex relationships between the data. These complex relationships are then utilized with notification rules to determine the types of goods/services that passengers of airline flights are most likely to need or want. These notification rules are further used to identify the registered vendors that provide the identified goods/services and then to send notifications to them of the potential business opportunity.

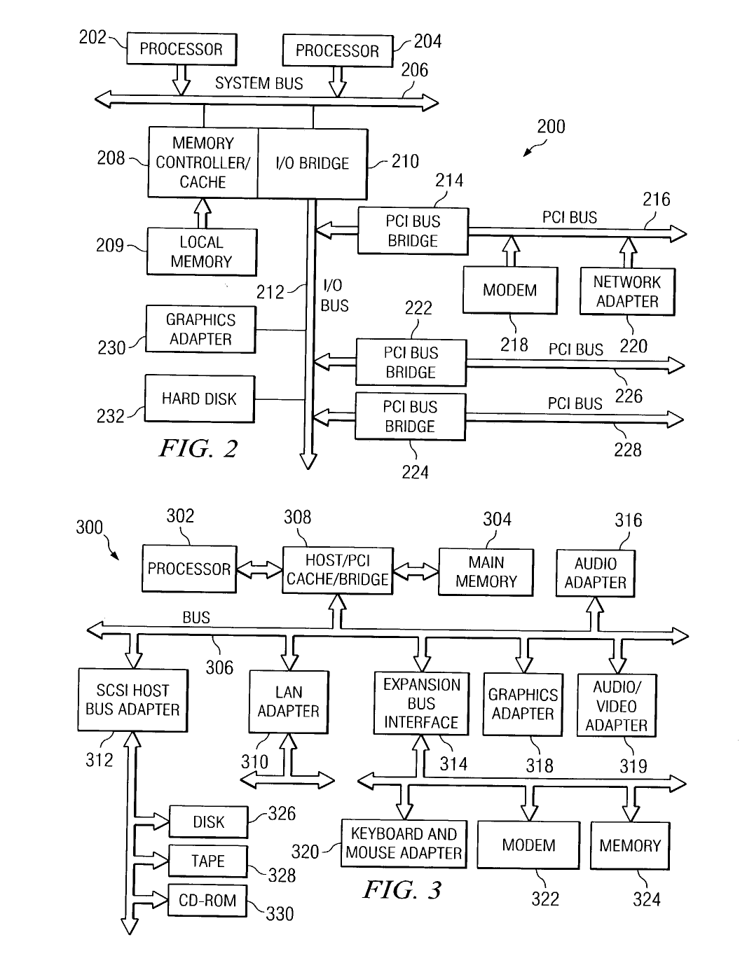

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The server as shown in FIG. 2 may be programmed with software instructions for performing the functionality of a server 104 or a server 105, for example. That is, when operating in the capacity of a FAA ETMS server 104, the server in FIG. 2 may have software instructions that facilitate the querying, updating and retrieval of FAA ETMS data in a storage device associated with the server 104. When operating in the capacity of a vendor notification system 170, the server shown in FIG. 2 may have software instructions for obtaining data form the FAA ETMS 160 and airline flight information system 150, performing data mining on the acquired data, applying one or more notification rules, determining whether to send a notification to a vendor, and instructions for generating and sending a notification to a vendor when conditions are present that indicate a notification should be sent.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With the present invention, the client device shown in FIG. 3 is a client device associated with a vendor of goods and services. The client device is used as a mechanism by which the vendor registers a vendor profile with the vendor notification system of the present invention and receives notifications from the vendor notification system of the present invention when conditions are present that warrant notifying the vendor. As such, the client device in FIG. 3, as previously stated, may take various forms and may be a personal computer, a network computer, a personal digital assistant, a mobile telephone, a pager device, a portable computer, or any other computing/communication device that is capable of receiving messages in a textual or audible format from the vendor notification system of the present invention. Although, in a preferred embodiment, the client device is used to both register a vendor profile and the receive notifications, it should be noted that the client device that is used to register a vendor profile may be different from the client device that receives notifications without departing from the spirit and scope of the present invention.

As previously mentioned, the present invention provides a mechanism for gathering flight information data from an FAA ETMS system and an airline flight information system, which may include passenger manifest information, and analyzing the data gathered to determine whether a vendor should be notified of potential business opportunities. The vendor notification may be performed based on vendor profiles registered with the system that indicate that types of conditions that the vendors wish to be notified about, based on identification of the vendors via data mining and notification rules, or any combination of the two approaches, for example.

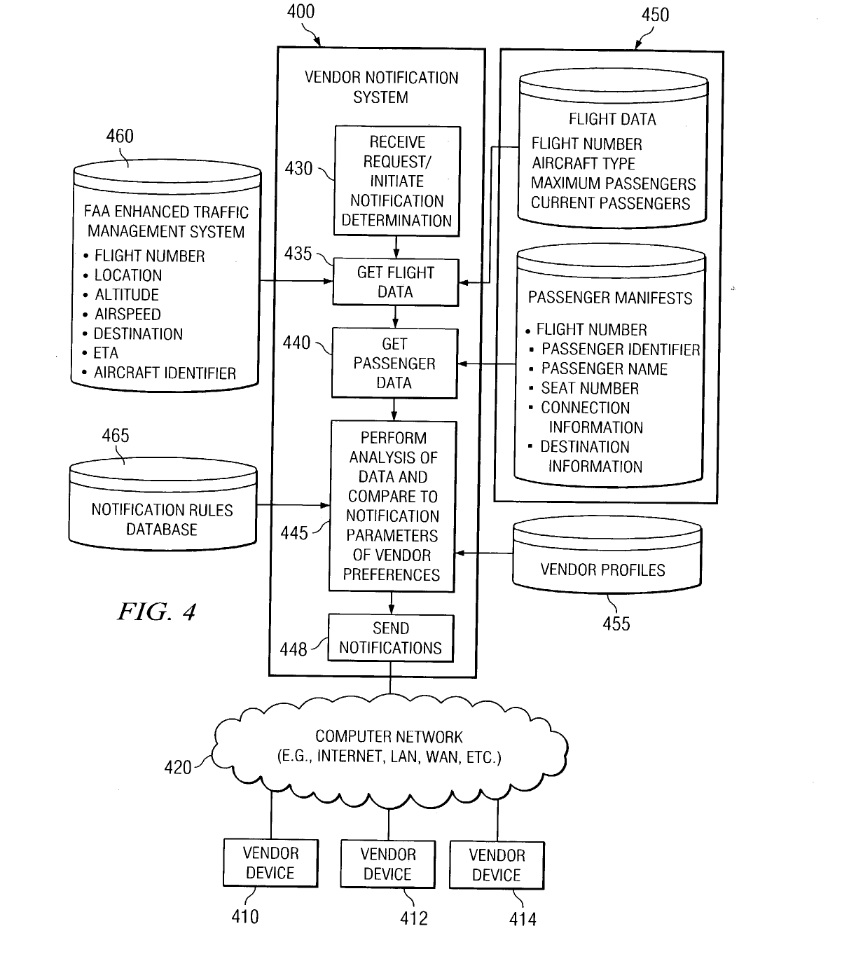

FIG. 4 is an exemplary block diagram illustrating an interaction of the vendor notification system with databases of flight, passenger and vendor information in accordance with an exemplary embodiment of the present invention. As shown in FIG. 4, a vendor notification system 400 initiates a notification determination operation either in response to a request received from a vendor device 410-414 via the network 420, or based on a predetermined criteria (430). For example, the notification determination may be performed at specific times, periodically based on an elapsed time since the last notification determination, or the like.

As part of this notification determination operation, the vendor notification system 400 obtains flight data from a FAA ETMS 460 and a airline flight information system 450 (435). This flight data may include, for example, the flight number, location, altitude, airspeed, destination, estimated time of arrival, aircraft identifier, current delay from scheduled arrival time, type of aircraft, maximum number of passengers, current number of passengers, gate assignments, and the like.

The vendor notification system 400 then obtains passenger manifest data from the airline flight information system 450 (440). This information may include, for example, a flight number, passenger identifier (e.g., frequent flyer card number or the like), passenger name, seat number, connection information, destination information, and the like.

All of this information is retrieved and is analyzed by the vendor notification system 400 to identify which vendors should receive notifications of conditions representative of a potential business opportunity. For example, notification rules may be applied to raw data to determine if the raw data meets threshold requirements established for vendors via registered vendor profiles. Alternatively, or additionally, data mining techniques may be used to identify relationships between the data that may indicate conditions which are of interest to vendors of goods and services to passengers of airline flights. The relationships may then be processed using notification rules to determine the types of goods/services that passengers of airline flights are most likely to be interested in and to identify the particular vendors present at the airport that provide those goods/services.

In either embodiment, or a combination of embodiments, once the vendors that are to receive notifications are identified, notification messages may then be sent to the identified vendor devices 410-414. These notifications may take the form of textual, graphical and/or audible messages sent to vendor devices 410-414 via the network 420. The vendor devices 410-414 may be computing devices associated with a vendor location, portable computing devices associated with a particular person associated with the vendor, or the like. In alternative embodiment, notifications may be posted to a central web site that is accessible by registered vendors via their vendor devices 410-414.

In one preferred embodiment of the present invention, the analysis performed on the flight data and passenger manifest data involves making straight forward determinations from the raw data and comparing these determinations to notification criteria set up by vendors via their registration of a vendor profile with the vendor notification system 400. For example, if a flight's ETA was originally established as 12:05 pm and its current ETA is 1:05 pm, it can be determined that the flight is one hour late. The determination that the flight is one hour late may be compared to criteria set by vendors indicating whether they wish to be notified of flights that are one hour late or not.

For example, a food vendor may wish to be notified if a flight is 30 minutes late or more. In such a case, having determined that this particular flight is one hour late, and comparing the one hour late condition with the notification criteria for the food vendor, a determination may be made that the food vendor-should receive a notification regarding this flight. The notification that is generated may provide identification information regarding the flight, the arriving gate, the number of passengers on board, the ETA, and the like. The notification may further include an indication as to why the notification is sent, i.e. what notification criteria was met. Based on this notification, the food vendor may wish to dispatch an employee to the arriving gate to inform passengers of special deals on food offered by the vendor or the like, in order to take advantage of this possible business opportunity.

As another example, the flight data that may be obtained includes the maximum number of passengers for a particular flight and the current number of passengers for the flight, i.e. the current number of passengers booked for a flight. It is not unusual for airlines to overbook flights in anticipation that some passengers may make changes in their flight arrangements and will not actually be on the flight that they originally booked. This is a way in which the airlines attempt to keep all flights at their maximum capacity to maximize profits.

By comparing the current number of passengers booked for a flight to the maximum number of passengers for a flight, a determination may be made as to whether the flight is overbooked or not. Typically, on overbooked flights, vouchers are offered to individuals who willingly give up their seats on the flight and agree to fly “stand-by” on a later flight. These individuals may be in need of food, ground transportation, or in more serious circumstances, hotel lodging. The present invention may determine an overbooked condition with regard to a flight and may compare this overbooked condition to the notification criteria of registered vendors.

Those vendors that have indicated that they wish to be notified of flights that are overbooked may then receive a notification indicating the flight, departure gate, the reason for the notification, the number of overbooked passengers, and other relevant information. The vendors may then take appropriate actions to maximize the business opportunity by, for example, sending a representative to the departure gate to advertise their goods/services, offer those persons that voluntarily give up their seats on the flight discounts on goods/services, and the like.

As yet another example of a relatively simple determination that may be made based on the data from the FAA ETMS and the airline flight information system, ETA and ETD (estimated time of departure) information of flights may be used to determine if a passenger will be able to make a connecting flight at an airport. That is, assume a first flight is one hour late such that the flight arrives at Dallas-Ft. Worth Airport at 12:05 pm. Also assume that the passenger's connecting flight is scheduled to depart Dallas-Ft. Worth Airport at 11:50 am and that the departing flight is on time. From the ETA and ETD of these flights, it can be determined that there is very little likelihood that the passenger will be able to make their connecting flight (since it leaves DFW airport before the flight that the passenger is on arrives at DFW). As a result, the determination is that there is a passenger on the flight that cannot make their connecting flight and this is a potential business opportunity for vendors. Vendors that have requested to be notified of passengers that cannot make their connecting flights may then be notified of the flight, passenger name, arriving gate, and the like, so that they may send a representative or otherwise advertise their goods/services to the passenger.

Thus, in one preferred embodiment, raw data, or relatively simple determinations made from the raw data, are used to compare to vendor notification criteria to determine if a particular vendor should receive a notification of a flight or not. In this way, vendors are apprised of potential business opportunities dynamically as these opportunities arise due to flight conditions.

In another preferred embodiment of the present invention, the analysis performed on the flight data and passenger manifest data retrieved by the vendor notification system 400 is a data mining analysis in which relationships between the data are identified and current conditions of the passengers on the flights analyzed are deduced from the relationships. These conditions are then applied to notification rules along with vendor profile preferences information to thereby identify which vendors of associated with an airport should be notified of the potential for a business opportunity.

The principles of data mining are generally known in the art. Data mining is a process for extracting relationships in data stored in database systems. As is well-known, users can query a database system for low-level information, such as the value of a particular attribute of a scheduled flight. Data mining systems, on the other hand, can build a set of high-level rules about a set of data, such as “If the flight is more than 10 minutes behind schedule, and there are connecting flights for passengers on the flight, and the current time at the airport is after 6:00 pm, then the probability that a passenger will need hotel accommodations is greater than 60%.” These rules allow a system to determine the relationship between the delay of a flight, passengers on the flight having connecting flights, and a current time at the airport and allows the system to determine if passengers on this flight are more likely to require certain services from vendors. This type of knowledge allows for targeted advertising of goods and services to passengers by vendors.

Data mining may be categorized into several tasks including association, classification, and clustering. Data mining may also make use of several knowledge discovery paradigms, such as rule induction, instance-based learning, neural networks, and genetic algorithms. Many combinations of data mining tasks and knowledge discovery paradigms are possible within a single application.

An association rule can be developed based on a set of data for which an attribute is determined to be either present or absent. For example, suppose data has been collected on a set of flights and the attributes are delay time and missed connections with connecting flights. The goal is to discover any association rules between the delay time and the missed connections. Specifically, given two non-intersecting sets of items, e.g., sets X and Y, one may attempt to discover whether there is a rule “if X is greater than 10 minutes, then Y is 10% of the passengers will miss their connections,” and the rule is assigned a measure of support and a measure of confidence that is equal or greater than some selected minimum levels. The measure of support is the ratio of the number of records where X is 10 minutes or more and Y is 10% of the passengers missed their connections, divided by the total number of records. The measure of confidence is the ratio of the number of records where X is 10 minutes or more and Y is 10% of the passengers missed their connections, divided by the number of records where X is 10 minutes or more.

Due to the smaller number of records in the denominators of these ratios, the minimum acceptable confidence level is higher than the minimum acceptable support level. Returning to airline flights as an example, the minimum support level may be set at 0.3 and the minimum confidence level set at 0.8. An example rule in a set of aircraft flight information that meets these criteria might be “if the flight is delayed by 10 minutes or more, then 10% of the passengers will miss their flights.”

Given a set of data and a set of criteria, the process of determining associations is completely deterministic. Since there are a large number of subsets possible for a given set of data and a large amount of information to be processed, most research has focused on developing efficient algorithms to find all associations. However, this type of inquiry leads to the following question: Are all discovered associations really significant? Although some rules may be interesting, one finds that most rules may be uninteresting since there is no cause and effect relationship. For example, the association “if the flight is delayed by 10 minutes or more, then 10% of the passengers will miss their connecting flights” would also be a reported association with exactly the same support and confidence values as the association “if 10% of the passengers of the flight miss their connecting flights, then the flight was delayed by 10 minutes or more.”

Classification tries to discover rules that predict whether a record belongs to a particular class based on the values of certain attributes. In other words, given a set of attributes, one attribute is selected as the “goal,” and one desires to find a set of “predicting” attributes from the remaining attributes. For example, suppose it is desired to know whether a passengers of a particular flight will need hotel accommodations. For example, a rather trivial example of this type of rule could include “If the flight is on time, then the passengers of the flight will not need hotel accommodations.” A set of data is presented to the system based on past knowledge; this data “trains” the system. The goal is to produce rules that will predict behavior for a future class of data. The main task is to design effective algorithms that discover high quality knowledge. Unlike an association in which one may develop definitive measures for support and confidence, it is much more difficult to determine the quality of a discovered rule based on classification.

A problem with classification is that a rule may, in fact, be a good predictor of actual behavior but not a perfect predictor for every single instance. One way to overcome this problem is to cluster data before trying to discover classification rules. To understand clustering, consider a simple case where two attributes are considered: flight delay and percent of passengers missing their connecting flight. These data points can be plotted on a two-dimensional graph. Given this plot, clustering is an attempt to discover or “invent” new classes based on groupings of similar records. For example, for the above attributes, a clustering of data in the range of 10 minutes of flight delay might be found for 10% of passengers missing their connecting flights. This cluster could then be treated as a single class.

Clusters of data represent subsets of data where members behave similarly but not necessarily the same as the entire population. In discovering clusters, all attributes are considered equally relevant. Assessing the quality of discovered clusters is often a subjective process. Clustering is often used for data exploration and data summarization.

There are a variety of knowledge discovery paradigms, some guided by human users, e.g. rule induction and decision trees, and some based on AI techniques, e.g. neural networks, that may be used with data mining. The choice of the most appropriate paradigm is often application dependent.

On-line analytical processing (OLAP) is a database-oriented paradigm that uses a multidimensional database where each of the dimensions is an independent factor, e.g., flight delay vs. missed connecting flights vs. time of day. There are a variety of operators provided that are most easily understood if one assumes a three-dimensional space in which each factor is a dimension of a vector within a three-dimensional cube. One may use “pivoting” to rotate the cube to see any desired pair of dimensions. “Slicing” involves a subset of the cube by fixing the value of one dimension. “Roll-up” employs higher levels of abstraction, e.g. moving from delay-by-flight to delay-by-time period, and “drill-down” goes to lower levels, e.g. moving from delay-by-time period to delay-by-flight.

The Data Cube operation computes the power set of the “Group by” operation provided by the Structure Query Language (SQL). For example, given a three dimension cube with dimensions A, B, C, then Data Cube computes Group by A, Group by B, Group by C, Group by A,B, Group by A,C, Group by B,C, and Group by A,B,C. OLAP is used by human operators to discover previously undetected knowledge in the database.

Recall that classification rules involve predicting attributes and the goal attribute. Induction on classification rules involves specialization, i.e. adding a condition to the rule antecedent, and generalization, i.e. removing a condition from the antecedent. Hence, induction involves selecting what predicting attributes will be used. A decision tree is built by selecting the predicting attributes in a particular order, e.g., probability of missed connecting flight, time of day, delay of flight.

The decision tree is built top-down assuming all records are present at the root and are classified by each attribute value going down the tree until the value of the goal attribute is determined. The tree is only as deep as necessary to reach the goal attribute. For example, if no flights in a particular period of time have a delay of 10 minutes or more, then the value of the goal attribute “Hotel Accommodations Required by Passengers?” would be determined (value equals “No”) once it is determined that there are no passengers that missed their connecting flight due to a delay. A human is often involved in selecting the order of attributes to build a decision tree based on “intuitive” knowledge of which attribute is more significant than other attributes.

Decision trees can become quite large and often require pruning, i.e. cutting off lower level subtrees. Pruning avoids “overfitting” the tree to the data and simplifies the discovered knowledge. However, pruning too aggressively can result in “underfitting” the tree to the data and missing some significant attributes.

The above techniques provide tools for a human to manipulate data until some significant knowledge is discovered and removes some of the human expert knowledge interference from the classification of values. Other techniques rely less on human intervention. Instance-based learning involves predicting the value of a tuple, e.g., predicting if someone of a particular age and gender will buy a product, based on stored data for known tuple values. A distance metric is used to determine the values of the N closest neighbors, and these known values are used to predict the unknown value. For example, given a particular flight delay and a particular time of day in which the tuple value is not known, if among the 20 nearest neighbors, 15 flights showed a particular percentage of passengers missing their connecting flights and 5 samples did not, then it might be predicted that the value of this new tuple would be “10% of the passengers will miss their connecting flights.” This technique does not discover any new rules, but it does provide an explanation for the classification, namely the values of the closest neighbors.

The final technique examined is neural nets. A typical neural net includes an input layer of neurons corresponding to the predicting attributes, a hidden layer of neurons, and an output layer of neurons that are the result of the classification. For example, there may be eight input neurons corresponding to “under 10 minutes of delay”, “between 10 and 20 minutes of delay”, “over 20 minutes of delay”, “after 6:00 pm”, “has passengers with connecting flights”, “arriving gate within 3000 feet of departing gate for connecting flight”, and “arriving gate more than 3000 feet away from departing gate of connecting flight.” There could be two output neurons: “will need hotel accommodations” and “will not need hotel accommodations”. A reasonable number of neurons in the middle layer is determined by experimenting with a particular known data set.

There are interconnections between the neurons at adjacent layers that have numeric weights. When the network is trained, meaning that both the input and output values are known, these weights are adjusted to give the best performance for the training data. The “knowledge” is very low level (the weight values) and is distributed across the network. This means that neural nets do not provide any comprehensible explanation for their classification behavior-they simply provide a predicted result.

Neural nets may take a very long time to train, even when the data is deterministic. For example, to train a neural net to recognize an exclusive-or relationship between two Boolean variables may take hundreds or thousands of training data (the four possible combinations of inputs and corresponding outputs repeated again and again) before the neural net learns the circuit correctly. However, once a neural net is trained, it is very robust and resilient to noise in the data.

The present invention may make use of any combination of these above data mining techniques and knowledge based paradigms to achieve the function of analyzing the flight data obtained from the FAA ETMS system and the airline flight information system along with passenger manifest information. The result of this data mining is the identification of certain complex conditions associated with each scheduled flights that identify needs of particular goods/services of passengers of those scheduled flights. Based on these identified needs, vendors may be identified that offer the goods/services of interest to those passengers and notifications may be sent to those vendors.

For example, rather than merely determining that a passenger is unable to make their connecting flight, the present embodiment may identify a much more complex condition that better identifies the types of goods/services that the passenger is likely to need. For example, using data mining and knowledge paradigms as discussed above, the present invention may determine that the passenger is unable to make their connecting flight, that there are no other flights to the same destination as the passenger's connecting flight on any airline until the following morning and thus, the passenger is most likely in need of hotel lodging, dining accommodations, and ground transportation. Furthermore, if the airline flight information system contains historical information for this passenger, a determination may be made as to the probability that the passenger will desire shuttle ground transportation or to rent a car based on previous behaviors of the passenger.

As a result of this determination, the registered vendors are identified that provide the goods/services identified as being of most interest to this passenger. That is, registered hotels, car rental agencies, and restaurants may be notified of the passenger's predicament and may be provided with an opportunity to advertise their goods/services to the passenger.

The advertising of goods/services, i.e. the solicitation of the passenger, may take many forms. As previously mentioned, such solicitation may take the form of a personal representative of the vendor being present at the arriving gate to personally interact with the passenger to offer the vendor's goods/services. In other embodiments, if the passenger has registered contact information, i.e. an electronic mail address, a cellular telephone number, an alphanumeric pager number, or the like, an advertisement of the vendor's goods/services may be automatically sent to the passenger without requiring a human representative to be present. In one particular embodiment, the present invention may make use of the passenger travel progress notification mechanism of the incorporated U.S. patent application Ser. No. 10/171,944 to provide advertising messages to passengers of flights whose conditions identify them as potential consumers of goods/services offered by a vendor.

As previously mentioned, the particular vendors to which notifications are to be sent may be identified based on vendor profiles submitted by vendors during a registration process. The vendor profiles may be submitted, for example, by a representative of the vendor logging onto the vendor notification system and submitting a vendor profile registration form.

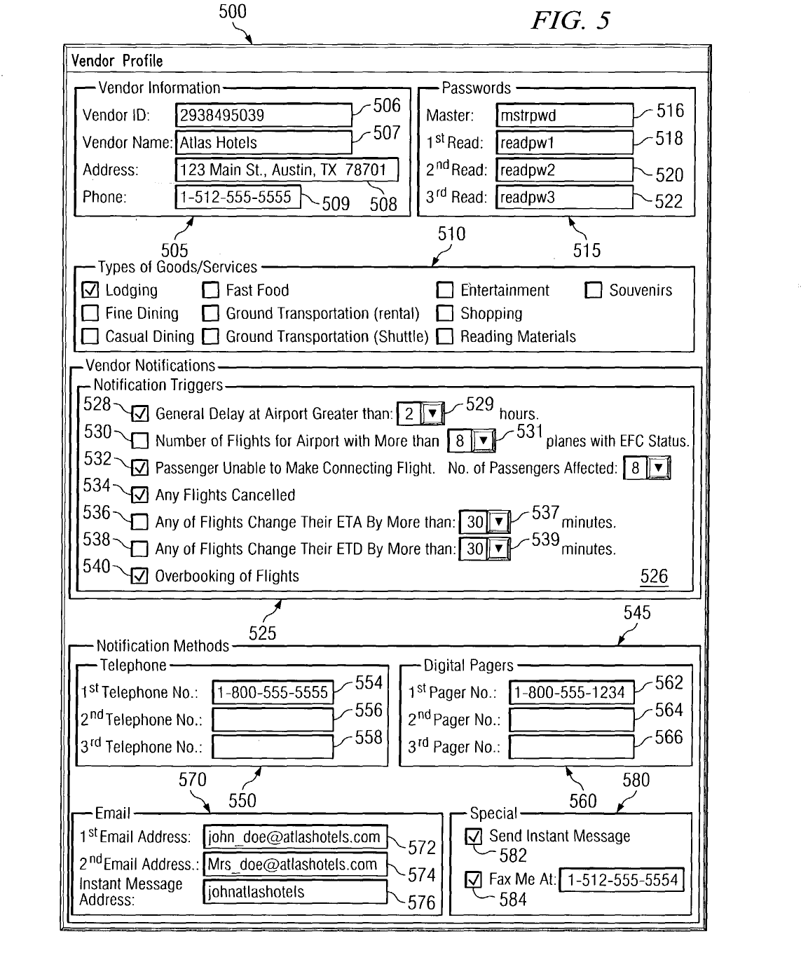

FIG. 5 is an exemplary diagram illustrating a vendor profile registration form according to one exemplary embodiment of the present invention. As shown in FIG. 5, the vendor profile registration from 500 includes a vendor information portion 505 having fields for inputting the vendor identification number 506, name of the vendor 507, address of the vendor location 508, telephone number of the vendor 509, and the like. The vendor profile registration form 500 further includes a services/goods designation portion 510. This portion 510 includes a plurality of fields for designating the types of services/goods provided by the vendor.

In addition to the above, the vendor profile registration form 500 includes a passwords portion 515 having fields 516-522 for designating passwords that may be used to access the vendor profile information. A vendor notifications portion 525 is also provided in which notification triggers 526 are identified using fields 528-540.

For example, fields 528 and 529 are used to select a notification trigger of delays of more than x number of hours. Fields 530 and 531 are used to select a notification trigger of more than x number of planes with an EFC status at the airport. Field 532 is used to select a notification trigger of passengers that are unable to make connecting flights. Field 534 is used to select a notification trigger of flights being canceled. Fields 536 and 537 are used to select a notification trigger of changes in flight ETAs that are more than x minutes. Fields 538 and 539 are used to select a notification trigger of flights that change their ETD by more than x minutes. Field 540 is used to select a notification trigger of overbooked flights.

In addition to the above, the vendor profile registration form 500 further includes a notification method portion 545 having telephone number portion 550, digital pager portion 560, email portion 570 and special notification portion 580. The telephone number portion 550 provides fields 554-558 for entry of telephone numbers that may be used to provide a notification to a vendor, e.g., a audible recorded message that identifies the flight number, gate assignment, reason for the notification, and the like. The digital pagers portion 560 contains fields 562-566 for entry of pager numbers that may be used to send alphanumeric notifications to a vendor. The email portion 570 contains fields 572-576 for entry of electronic mail addresses to which notifications may be sent to vendors as electronic mail messages.

The special notification portion 580 includes fields 582 and 584 for indicating special forms of notification that may be used to notify the vendor. In the depicted example, the special notifications may be by instant message using an instant messaging address defined in field 576 or a facsimile message sent to the facsimile number designated in field 584.

The vendor profile established using the vendor profile registration form 500 may be consulted during analysis of flight and passenger manifest data to determine which registered vendors should receive notifications of business opportunities. For example, the notification triggers for a vendor may be identified during analysis of the flight and passenger data to determine if the analysis of the flight and passenger data leads to a determination that falls within one or more of the triggers. For example, the flight and passenger manifest data may be analyzed to determine that a flight is late and that a passenger on the flight will not be able to make their connecting flight. As a result, since the depicted vendor wishes to be notified when a passenger is unable to make a connecting flight (element 532), the vendor associated with the depicted vendor profile registration form, i.e. Atlas Hotels, will receive a notification from the vendor notification system.

In an alternative embodiment, such as an embodiment in which data mining is utilized to identify the most probable goods and services of interest to passengers, the types of goods and services registered by the vendor may be used to determine if the vendor provides the goods and services that have been identified as being most likely to be of interest to the passengers. Registered vendors that provide the identified goods and services may then have notifications sent to them indicating the potential business opportunity.

When sending a notification to the vendor in the depicted example, a hierarchy of notification attempts may be made. That is, a notification may first be sent to the instant messaging address and a determination is made as to whether an acknowledgement is received from the vendor, i.e. a response indicating someone at the instant messaging address received the notification message. If an acknowledgement is not received within a predefined period of time, a next attempt may involve sending a notification message to the electronic mail addresses shown in portion 570. Again, if an acknowledgement is not received, a pager message and/or a telephone message may be attempted. Finally, a facsimile transmission will be attempted.

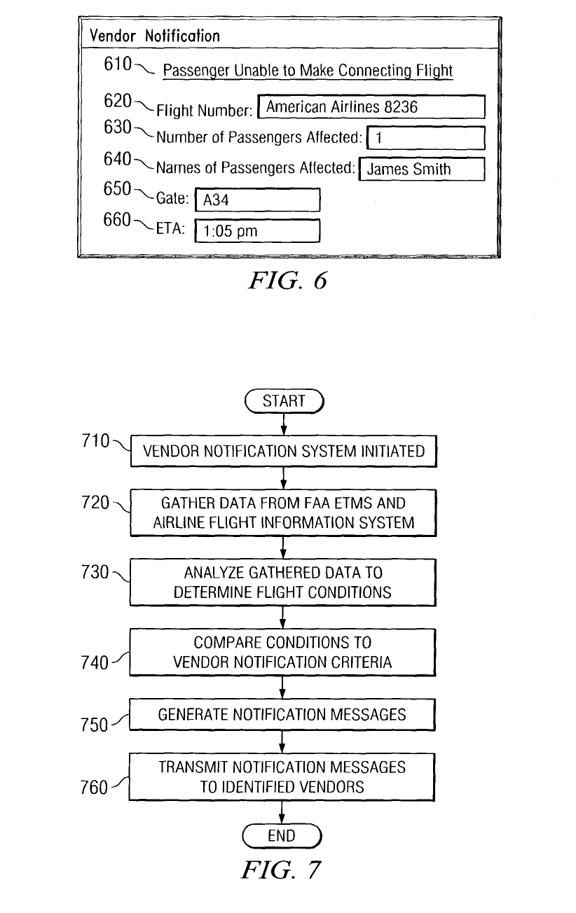

FIG. 6 is an exemplary diagram of a notification sent to a vendor computing device in accordance with the present invention. As shown in FIG. 6, the notification includes a reason 610 for the notification, a flight identifier 620, number of passengers affected by the notification 630, an optional passenger name list 640, an arrival or departure gate assignment 650, an ETA or ETD 660, and the like. The depicted notification is an alphanumeric text message that may be sent via an instant messaging system, electronic mail, pager message, or the like. In addition, notifications may be made audible by synthesized voice or prerecorded messages that are output via a telephone system or the like. Such audible messages may include similar information to that illustrated in FIG. 6.

FIG. 7 is a flowchart outlining an exemplary operation of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustrations, can be implemented by special purpose hardware-based computer systems which perform the specified functions or steps, or by combinations of special purpose hardware and computer instructions.

As shown in FIG. 7, the vendor notification system is initiated (step 710) and data is gathered from the FAA ETMS and airline flight information system (step 720). The data is then analyzed according to notification rules and/or data mining algorithms to determine conditions of the flights scheduled for the particular airport (step 730). These conditions are then compared to vendor profiles registered with the notification system to determine which vendors are to be provided with notification messages (step 740). Notification messages are then generated for each vendor that is identified based on the type of notification criteria that matched the vendor's profile (step 750). The notification messages are then transmitted to the vendors using the contact information stored in the vendors' profiles (Step 760). The operation then terminates.

Thus, the present invention provides a mechanism for analyzing flight and passenger manifest data to determine conditions of flights and then to identify vendors that are to be informed of these conditions of flights associated with an airport. The present invention may then generate notifications based on the type of notification criteria matched by the current conditions of the flights and send those notifications to the vendors using contact information registered by the vendors. In this way, vendors are provided with dynamic information regarding flights into and out of an airport so that they may identify potentially profitable business opportunities with regard to the passengers of these flights.

It should be noted that while the preferred embodiments have been described as being used with airlines and airport vendors, the present invention is not limited to such. Rather, the present invention may be applied to vendor situations associated with any type of transportation in which scheduling changes of transportation may be of importance to vendors for identifying potential business opportunities. Such transportation may include, for example, trains, buses, cruise ships, and other forms of public and/or private transportation.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of notifying a vendor of goods/services to passengers of vehicles of a change in a transportation schedule for a vehicle, comprising:
identifying conditions associated with the transportation schedule for the vehicle;
determining if the conditions meet one or more notification criteria for the vendor; and
sending a notification to the vendor identifying the transportation schedule and indicating the conditions meeting the one or more notification criteria.

2. The method of claim 1, wherein identifying conditions associated with the transportation schedule for the vehicle includes:
obtaining information from at least one tracking system that tracks a current situation of the vehicle with regard to the transportation schedule.

3. The method of claim 2, wherein identifying conditions associated with the transportation schedule for the vehicle includes:
obtaining information about the vehicle and passengers of the vehicle from an information source; and
using the current situation information, transportation schedule information, and information about the vehicle and passengers to identify conditions associated with the transportation schedule.

4. The method of claim 3, wherein the tracking system is a Federal Aviation Administration Enhanced Traffic Management System, and wherein the information source is an airline flight information system.

5. The method of claim 1, wherein the one or more notification criteria are part of a vendor profile registered by the vendor via a vendor client device.

6. The method of claim 3, wherein using the current situation information, the transportation schedule, and information about the vehicle and passengers to identify conditions associated with the transportation schedule includes performing data mining operations on the current situation information, the transportation schedule information and the information about the vehicle and passengers to identify relationships between various portions of the current situation information, transportation schedule information and the information about the vehicle and passengers.

7. The method of claim 1, wherein sending a notification to the vendor includes at least one of transmitting a notification message to a registered vendor client device and posting a notification to a central web site accessible by the vendor via a vendor client device.

8. The method of claim 6, wherein performing data mining operations results in a determination as to the particular goods or services that may be of interest to passengers of the vehicle, and wherein determining if the conditions meet one or more notification criteria for the vendor includes identifying whether the vendor offers one or more of the goods or services.

9. The method of claim 1, wherein the one or more notification criteria includes one or more of delay criteria, whether a passenger is unable to make a connecting flight, cancellation of a flight, a change in an estimated time of arrival of more than a predetermined amount of time, a change in an estimated time of departure that is more than a predetermined amount of time, and overbooking of a flight.

10. The method of claim 1, wherein the notification includes one or more of a flight number, a reason for the notification, a number of passengers affected by the conditions, name(s) of the passenger(s) affected by the conditions, a gate associated with the flight, and an estimated time of arrival or an estimated time of departure.

11. A computer program product in a computer readable medium for notifying a vendor of goods/services to passengers of vehicles of a change in a transportation schedule for a vehicle, comprising:
first instructions for identifying conditions associated with the transportation schedule for the vehicle;
second instructions for determining if the conditions meet one or more notification criteria for the vendor; and
third instructions for sending a notification to the vendor identifying the transportation schedule and indicating the conditions meeting the one or more notification criteria.

12. The computer program product of claim 11, wherein the first instructions for identifying conditions associated with the transportation schedule for the vehicle include:
instructions for obtaining information from at least one tracking system that tracks a current situation of the vehicle with regard to the transportation schedule.

13. The computer program product of claim 12, wherein the first instructions for identifying conditions associated with the transportation schedule for the vehicle include:
instructions for obtaining information about the vehicle and passengers of the vehicle from an information source; and
instructions for using the current situation information, transportation schedule information, and information about the vehicle and passengers to identify conditions associated with the transportation schedule.

14. The computer program product of claim 13, wherein the tracking system is a Federal Aviation Administration Enhanced Traffic Management System, and wherein the information source is an airline flight information system.

15. The computer program product of claim 11, wherein the one or more notification criteria are part of a vendor profile registered by the vendor via a vendor client device.

16. The computer program product of claim 13, wherein the instructions for using the current situation information, the transportation schedule, and information about the vehicle and passengers to identify conditions associated with the transportation schedule include instructions for performing data mining operations on the current situation information, the transportation schedule information and the information about the vehicle and passengers to identify relationships between various portions of the current situation information, transportation schedule information and the information about the vehicle and passengers.

17. The computer program product of claim 11, wherein the third instructions for sending a notification to the vendor include at least one of instructions for transmitting a notification message to a registered vendor client device and instructions for posting a notification to a central web site accessible by the vendor via a vendor client device.

18. The computer program product of claim 16, wherein the instructions for performing data mining operations results in a determination as to the particular goods or services that may be of interest to passengers of the vehicle, and wherein the second instructions for determining if the conditions meet one or more notification criteria for the vendor include instructions for identifying whether the vendor offers one or more of the goods or services.

19. The computer program product of claim 11, wherein the one or more notification criteria includes one or more of delay criteria, whether a passenger is unable to make a connecting flight, cancellation of a flight, a change in an estimated time of arrival of more than a predetermined amount of time, a change in an estimated time of departure that is more than a predetermined amount of time, and overbooking of a flight.

20. The computer program product of claim 11, wherein the notification includes one or more of a flight number, a reason for the notification, a number of passengers affected by the conditions, name(s) of the passenger(s) affected by the conditions, a gate associated with the flight, and an estimated time of arrival or an estimated time of departure.

21. An apparatus for notifying a vendor of goods/services to passengers of vehicles of a change in a transportation schedule for a vehicle, comprising:
means for identifying conditions associated with the transportation schedule for the vehicle;
means for determining if the conditions meet one or more notification criteria for the vendor; and
means for sending a notification to the vendor identifying the transportation schedule and indicating the conditions meeting the one or more notification criteria.
